(19) United States
(12) Patent Application Publication
(10) Pub. No.: US 2019/0262903 A1
(43) Pub. Date: Aug. 29, 2019

(54) APPARATUS AND METHODS FOR MICROWAVE DENSIFICATION

(71) Applicant: METALLUM3D INC., Crozet, VA (US)

(72) Inventor: Nelson ZAMBRANA, Crozet, VA (US)

(73) Assignee: METALLUM3D INC., Crozet, VA (US)

(21) Appl. No.: 16/320,236

(22) PCT Filed: Aug. 3, 2017
(86) PCT No.: PCT/US17/45228

§ 371 Date: Jan. 24, 2019

Related U.S. Application Data
(60) Provisional application No. 62/371,747, filed on Aug. 6, 2016.
(60) Provisional application No. 62/507,712, filed on May 17, 2017.

(51) Int. Cl. B22F 3/26; B22F 1/00; B22F 3/00; B22F 3/10; B29C 67/04; H05B 6/80

(52) U.S. Cl. CPC B22F 3/26; B22F 1/0014; B22F 3/003; B22F 3/1021; B33Y 40/00; H05B 6/80; B22F 2998/10; B22F 2999/00; B29C 67/04

(57) ABSTRACT

Disclosed herein are apparatus and methods for densification of a green part composed of metal powders held by a binder under a controlled atmosphere with microwave energy. In particular embodiments, the microwave densification can occur in a continuous, uninterrupted sequence, including the steps of thermal debinding, sintering and infiltration with a secondary infiltrant metal powder. In specific embodiments, the secondary infiltrant metal powder has a lower melting temperature than the metal powders in the green part, and the powder size ratio between the metal powders in the green part and the secondary infiltrant metal powder is selected such that the heating rates of the powders under microwave energy are approximately equalized.

### CROSS-REFERENCE TO RELATED APPLICATIONS

This application claims priority to U.S. Provisional Patent Application Ser. No. 62/371,747, filed Aug. 6, 2016 and U.S. Provisional Patent Application Ser. No. 62/507,712, filed May 17, 2017, the entire contents of each of which are incorporated herein by reference.

### BACKGROUND INFORMATION

Powder metallurgy describes various processes in which materials or components are made from metal powders. Powder metallurgy processes can avoid, or greatly reduce, the need to use metal removal processes, thereby significantly reducing material losses and manufacturing costs.

Densification of green parts made from metal powder particulate held by a binder is one of the steps typically performed during powder metallurgy process. The densification is commonly accomplished by conventional heating methods (including for example, radiant, resistance, and/or convection heating). Densification using conventional heating methods typically includes the steps of thermal debinding, sintering and optionally metal infiltration.

A more recent and faster method for densification of parts made from powdered particulate uses microwave energy. Various energy sources, including microwave energy, can also be used for debinding and sintering parts made from powdered particulates held by polymeric binders. Additionally, microwave energy has been used to infiltrate porous ceramics preforms with metal to form reaction bonded ceramic-metal composites.

Microwave densification of metallic powdered materials has been accomplished for the past two decades and has many advantages over the conventional methods. Some of these advantages include: time and energy saving, very rapid heating rates (e.g. greater than 400 degrees Celsius per minute), considerably reduced processing time and temperature, better microstructures and hence improved mechanical properties, environment friendly, etc.

However, existing apparatus and methods do not provide continuous densification of a green part (comprising metal powders in a binder) under microwave energy including the steps of debinding, sintering and infiltration with a secondary metal powder.

The use of microwave processing can reduce sintering time by a factor of ten or more, which can minimize grain growth. The fine initial microstructure can be retained without using grain growth inhibitors and hence achieve high mechanical strength. The heating rates for a typical microwave process are high and the overall cycle times are reduced by similar amounts as with the process sintering time, including for example, from hours or days to minutes.

Despite many advantages, there are some difficulties with microwave densification. In particular there are difficulties with the measurement and control of the temperature during microwave heating. For example, if a thermocouple is used, it should not be susceptible to microwave heating at the same frequency as the samples being heated. Furthermore, the thermocouple probe should be shielded and earthed or it may be damaged by arcing. Additionally, for correct temperature measurements, the thermocouple should be in close proximity to the part being heated.

In another example microwave densification, the use of an infra-red pyrometer for temperature measurement and control requires positioning the pyrometer outside of the microwave cavity, looking through a window, with a clear line of sight to the part being heated inside the microwave cavity. This arrangement can be problematic if the part inside the microwave cavity is covered or obscured by an insulating material. Additionally, the use of an infrared pyrometer generally requires the use of a thermocouple for proper calibration of the infrared pyrometer.

Another difficulty related to microwave densification is the control of the densification environment. Traditionally, the containment of the controlled gas and/or vacuum atmosphere has been provided by the microwave furnace cavity itself. This requires the microwave furnace cavity to have adequate sealing and be made of heavy duty materials with sufficient strength to withstand the mechanicals loads generated from operating in a vacuum. This can add considerable cost to the microwave furnace.

Furthermore, microwave cavities can suffer from hot and cold spots due to standing waves being generated inside the microwave cavity at the fixed operating frequency. As result of these hot and cold spots, it can be challenging to achieve a homogenous temperature distribution during microwave densification. By using a turntable or mode stirrer the effects of cold and hot spots within the microwave cavity can be reduced, but not eliminated.

Examples of existing apparatus and processes providing densification with microwave energy are identified below. A review of the references indicates that metal infiltration of a metal powder preform with a secondary metal powder under microwave energy is not considered by the references described below.

Canadian Patent 2,124,093 (“Microwave Sintering Process”) describes a process of sintering a material selected from the group consisting of ceramics, ceramic composites and metal materials, including surrounding the material to be sintered with a granular susceptor bed. The disclosed bed comprises: (a) a major amount of a microwave susceptor material, and (b) an amount less than 10% by weight of a refractory parting agent, either mechanically dispersed with the susceptor material, or as a coating on the susceptor material, to form granules; introducing a flow of a protective gas around the material to be sintered such that the protective gas flows through the bed; and irradiating the material to be sintered and the granular susceptor bed with microwave energy. This reference is one of the earlier known references involving microwave sintering of metal powder particulate. This reference refers to the use of microwave energy to sinter green parts composed of ceramic and metallic powders which have been compacted under high pressure from ceramic and metallic powders.

U.S. Pat. No. 6,183,689 (“Process for Sintering Powder Metal Components”) provides a method of sintering a metal powder green part which comprises powder metal, a powder metal alloy or a powder metal composition, by subjecting it to microwave energy for a predetermined time wherein the microwave frequency is 2.45 GHz and the time is less than 1 hour. This reference refers to the use of microwave energy to sinter green parts composed of metallic powders which have been compacted under high pressure.

U.S. Patent Application 2005/0249627 (“Manufacturing Process Using Microwave for Thermal Debinding”) describes a manufacturing process using microwaves for thermal debinding of powder metallurgy parts, where metal powder is mixed with polymer materials such as adhesives, fillings or lubricants, and a body is formed by means of molding, forging, extrusion, injection or scraping. The body to be debinded is placed in a microwave environment in an exposed manner or covered with powder, and power and work time of microwave are set for rapidly heating and debinding the body. This reference refers to the use of microwave energy to debind and sinter green parts of metallic particles held by a binder which have been generated by various manufacturing methods.

U.S. Pat. No. 8,431,071 titled “Sintering of Metal and Alloy Powders by Microwave/Millimeter-Wave Energy describes a method of sintering by placing a compacted metal powder inside a cylindrically-shaped susceptor in an inert atmosphere or a vacuum, and applying microwave or millimeter-wave energy to the powder until the powder is sintered. This patent refers to the use of microwave energy to sinter green parts composed of titanium powders which have been compacted under high pressure.

U.S. Patent Application 2006/0251536 (“Microwave Processing of MIM Preforms”) describes a method of producing a metallic component including providing a mixture of a metallic powder and a binder; melting the binder and forming the mixture into a preform in the shape of the component; removing a majority of the binder from the preform; and heating the preform with microwave energy to remove the remainder of the binder and to sinter the metal powder together to form the component. This patent refers to injection molded parts partially debound in a solvent, and further debound and sintered using microwave energy.

A publication by Veronesi et al. titled “Microwave Rapid Debinding and Sintering of MIM/CIM Parts” describes microwave assisted debinding and sintering of MIM/CIM parts made of stainless steel and alumina, which have been optimized by numerical simulation, in order to determine the most favorable load configuration in terms of heat generation, homogeneity and energy efficiency. This publication applies to partial solvent debinding and the optimized use of microwave energy to debind and sinter green parts of metallic and ceramic particles held by a binder which have been generated by injection molding.

U.S. Patent Application 2004/0238794 titled “Microwave Processing of Composite Body Made by an Infiltration Route describes a process where metal-ceramic composite materials are prepared with microwave energy. Specifically, microwave energy is used to heat and melt a source of silicon metal, which in turn infiltrates a carbon-containing ceramic preform to make reaction-bonded silicon carbide composites. This reference applies to the use of microwave energy for the generation of a reaction bonded ceramic-metal composites by infiltrating a metal into a ceramic porous preform.

As noted in the summaries provided above, the references do not refer to metal infiltration of a metal powder preform with a secondary metal powder under microwave energy.

### SUMMARY

Embodiments of the present disclosure address the need for continuous microwave densification and provide for metal infiltration of a metal powder preform with a secondary metal powder under microwave energy. Exemplary embodiments include continuous microwave densification methods, as well as apparatus and systems configured to perform such methods. Embodiments of the present disclosure can provide a number of benefits over existing apparatus, systems and methods, including cost effectiveness, highly reduced processing times, defect free parts and dimensional compliance.

Certain embodiments of the present disclosure may comprise a furnace configured for manufacturing of parts made from metal particulate. Specific embodiments can comprise a microwave cavity made from lightweight, microwave reflective materials. The use of lightweight, microwave reflective materials can reduce the cost of and weight the microwave cavity.

Particular embodiments can also include a plurality of solid state microwave sources with phase, frequency and amplitude control to irradiate the microwave cavity with microwave energy. The use of multiple, optimally located, solid state microwave sources can allow for precise control of the magnitude and distribution of the microwave energy, which can eliminate the standing waves and result in homogenous temperature distribution during microwave densification.

Certain embodiments may also include a removable, high temperature environmental chamber, made from microwave transparent materials capable of withstanding mechanical loads such as those generated by operating in a vacuum. The removable environmental chamber can maximize the utilization of the microwave furnace by allowing the user to prepare one or more environmental chambers for microwave densification while the microwave densification furnace is in use. By utilizing multiple environmental chambers the loading and unloading of the chambers into the microwave cavity can be fully automated.

In addition, specific embodiments may comprise a control system to control the environmental chamber with either vacuum or inert gases. In certain embodiments, the control system may use a standardized set of inputs and an algorithm to automatically generate an optimized thermal profile for microwave densification. The standardized set of inputs can include type of material, material properties and physical attributes, including for example, volume, surface area and part thickness.

Particular embodiments may also include an indirect temperature control system that uses a predictive algorithm to control the temperature of the parts during microwave densification without direct temperature feedback. The cost of high temperature measurement devices is a significant cost driver that can increase the overall cost of a microwave sintering furnace. In addition, these high temperature measuring devices have unique operational and calibration requirements. By eliminating the need for direct temperature feedback, operational cost and complexity can be reduced.

Specific embodiments can also include a microwave control system configured to control the phase, frequency and amplitude of the microwave sources during densification. Microwave densification requires accurate control of the microwave densification which can include the steps of debinding, sintering and infiltration.

Certain embodiments include a method of microwave densification of a component, where the method comprises: placing a component inside a microwave furnace, wherein the component comprises a binder and a first metal powder; placing a second metal powder in contact with the component; and irradiating the component and the second metal powder with microwave energy in a continuous microwave densification process to thermally debind and sinter the component and to infiltrate the component with the second metal powder.

In particular embodiments, the first metal powder has a first heating rate when the component is irradiated with microwave energy in the continuous microwave densification process; the second metal powder has a second heating rate when the second metal powder is irradiated with microwave energy in a continuous microwave densification process; the second heating rate is greater than 70 percent of the first heating rate; and the second heating rate is less than 130 percent of the first heating rate. In some embodiments, the second heating rate is greater than 80 percent of the first heating rate; and the second heating rate is less than 120 percent of the first heating rate. In specific embodiments, the second heating rate is greater than 90 percent of the first heating rate; and the second heating rate is less than 110 percent of the first heating rate.

In certain embodiments, the first metal powder comprises metal particles with a first particle size; the first metal powder has a first heating rate when the component is irradiated with microwave energy in the continuous microwave densification process; the second metal powder comprises metal particles with a second particle size; the second metal powder has a second heating rate when the component is irradiated with microwave energy in the continuous microwave densification process; and the method further comprises controlling a ratio of the first particle size to the second particle size such that the second heating rate that is between 70 percent and 130 percent of the first heating rate. In particular embodiments, the method further comprises controlling a ratio of the first particle size to the second particle size such that the second heating rate that is between 80 percent and 120 percent of the first heating rate. In some embodiments, method further comprises controlling a ratio of the first particle size to the second particle size such that the second heating rate that is between 90 percent and 110 percent of the first heating rate.

In specific embodiments, the component is generated by injection molding of the metal powder held by the binder. In certain embodiments, the component is generated by additive manufacturing of the metal powder held by the binder. In some embodiments, the component is generated by compacting the metal powder with the binder in a powder metallurgy press. Specific embodiments further comprise exposing the component to a solvent to remove a portion of the binder.

In certain embodiments, the metal powder has first density; the component has a second density; and the second density is between 50 percent and 95 percent of the first density. In particular embodiments, the microwave energy has a frequency from 0.8 to 90 GHz. In some embodiments, the component is placed inside an insulated vessel inside the microwave furnace. Specific embodiments further comprise placing a vacuum on the insulated vessel. Certain embodiments further comprise introducing an inert gas into the insulated vessel.

In particular embodiments, the component is sintered at a first temperature; the component is infiltrated with the second metal powder at a second temperature; and the first temperature is lower than the second temperature. In some embodiments, the second metal powder has a lower melting temperature than the melting temperature of the first metal powder. In specific embodiments, the component comprises a first volume; the second metal powder comprises a second volume; and the second volume is between 5 and 50 percent of the first volume.

Certain embodiments include an apparatus for microwave densification, where the apparatus comprises a microwave densification chamber comprising: a first microwave energy source; a first waveguide; and a chamber volume. Particular embodiments include a control system coupled to the first microwave energy source, where: the first microwave energy source is configured to radiate microwave energy into the first waveguide and irradiate the chamber volume with microwave energy; and the control system is configured to modulate parameters of the microwave energy source such that microwave chamber is irradiated with microwave energy to maintain a temperature versus time heating profile for microwave densification.

In some embodiments, the temperature versus time heating profile comprises: a first profile segment for increasing temperature inside the chamber volume; a second profile segment for maintaining temperature inside the chamber volume; a third profile segment for increasing temperature inside the chamber volume; a fourth profile segment for maintaining temperature inside the chamber volume; a fifth profile segment for increasing temperature inside the chamber volume; and a sixth profile segment for maintaining temperature inside the chamber volume.

In specific embodiments, the first and second profile segments are configured to debind a component comprising a binder and a first metal powder in the chamber volume; the third and fourth profile segments are configured to sinter the component; and the fifth and sixth profile segments are configured to infiltrate the component with a second metal powder. In certain embodiments, the parameters of the microwave energy source include an amplitude, a frequency or a phase of the microwave energy. In some embodiments, the control system is configured to generate the temperature versus time heating profile for microwave densification. In specific embodiments, the control system is configured to automatically generate the temperature versus time heating profile for microwave densification based on input parameters. In certain embodiments, the input parameters include material properties of a component for microwave densification. In particular embodiments, the material properties include material type, volume, surface area or thickness.

Some embodiments, further comprise an insulated vessel located within the microwave densification chamber, where the insulated vessel comprises an interior volume. In specific embodiments, the insulated vessel is formed from microwave transparent materials. Certain embodiments, further comprise: a first port in fluid communication with the interior volume of the insulated vessel; and a second port in fluid communication with the interior volume of the insulated vessel. In particular embodiments, the first port is coupled to a vacuum source; and the second port is coupled to an inert gas source. Some embodiments, further comprise: a first valve in fluid communication with the first port; and a second valve in fluid communication with the first port. In specific embodiments, the control system is configured to control the first valve and the second valve. In certain embodiments, the microwave densification chamber comprises microwave reflective materials.

In particular embodiments, the control system comprises an indirect temperature control system that uses a predictive algorithm to control a temperature of a component in the microwave densification chamber during microwave densification without direct temperature feedback. In some embodiments, the temperature versus time heating profile comprises one or more ramp profile segments for increasing temperature inside the chamber volume; the temperature versus time heating profile comprises one or more hold profile segments for maintaining temperature inside the chamber volume; and the algorithm is based on analytical data to calculate microwave power required for the one or more ramp profile segments and for the one or more hold profile segments.

As explained more fully below, embodiments of the present disclosure include apparatus, methods and system to provide for continuous microwave densification and address issues with existing technologies.

In the following, the term “coupled” is defined as connected, although not necessarily directly, and not necessarily mechanically.

The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

As used herein, a “green part” is a part comprising a thermally and/or solvent decomposable binder with at least one metal powder.

As used herein, a “brown part” is a green part that has had the binder removed, leaving a lightly sintered, porous metal skeleton.

As used herein, a “continuous microwave densification” method is a method that performs the steps of thermal debinding, sintering and infiltration without the need to access or otherwise manipulate the green part, the brown part or the infiltrant metal powder within the microwave furnace once the microwave irradiation process begins.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a schematic view of a flow chart is for steps in a microwave densification process according to embodiments of the present disclosure.

FIG. 2 is a schematic view of a densification vessel configured for use in exemplary embodiments of the present disclosure, including the embodiment illustrated in FIG. 1.

FIG. 3 is a schematic view of a microwave densification chamber configured for use in exemplary embodiments of the present disclosure, including the embodiment illustrated in FIG. 1.

FIG. 4 is a schematic view of a system with the densification vessel of FIG. 2 located inside microwave densification chamber of FIG. 3.

FIG. 5 is a graph of a typical temperature versus time heating profile for use in exemplary embodiments of the present disclosure, including the embodiment illustrated in FIG. 1.

FIG. 6 is a schematic of a flow chart of steps taken by a control system configured for use in exemplary embodiments of the present disclosure, including the embodiment illustrated in FIG. 1.

### DETAILED DESCRIPTION OF EXEMPLARY EMBODIMENTS

Exemplary embodiments of the present disclosure include a microwave densification process where a green part composed of metal powders held by a binder is densified under a controlled atmosphere with microwave energy. Particular exemplary embodiments include a microwave densification that occurs in a continuous, uninterrupted sequence, including the steps of thermal debinding, sintering and infiltration with a secondary infiltrant metal powder having a lower melting temperature than the metal powders in the green part. In exemplary embodiments, the powder size ratio between the metal powders in the green part and the secondary infiltrant metal powder can be selected such that the heating rates of the powders under microwave energy are approximately equalized. Accordingly, embodiments of the disclosed microwave densification process can reduce manufacturing time, costs and defects. In addition, embodiments of the disclosed process can provide a dimensionally compliant method for the densification of three dimensional objects made from metal powder particulate.

As previously noted, densification of green parts made from metal powder particulate held by a binder is commonly accomplished by conventional heating methods. Densification using such conventional methods typically includes the steps of thermal debinding, sintering and optionally metal infiltration.

Conventional thermal densification involves radiant, resistance and/or convection heating followed by the transfer of thermal energy via conduction to the inside of the workpiece through a thermal conductivity mechanism. Conventional densification is a rather slow process and takes considerable time to achieve thermal equilibrium. It is independent of the nature of the material. One can heat any material in a conventional densification process.

In contrast, microwave densification is fundamentally different from conventional thermal densification. In the case of microwave densification, heating is due to the simultaneous absorption/coupling of the microwave field with the metal powder and the conversion of the electromagnetic energy into thermal energy. This is known a volumetric heating.

In volumetric heating a thermal conductivity mechanism is not involved. The heating is virtually instantaneous and rapid, and is a function of the material under process. The heat is generated internally within the material instead of originating from the external sources, and transmits towards outside. Hence, there is an inverse heating profile, inside-out unlike in a conventional heating outside-in. In general, microwave heating is very rapid, as energy conversion, rather than energy transfer, heats the material.

A “green part” is generated in the initial stages of exemplary embodiments of the method disclosed herein. The green part may be generated by any suitable process, including for example, injection molding, additive manufacturing or powder metallurgy methods. In exemplary embodiments, the green part comprises thermally decomposable binders with metal powders.

In exemplary embodiments, the particle size of the metal powders in the green part is selected in relation to the particle size of a secondary infiltrant metal powder. The particle size ratio and the associated material properties between the metal powders in the green part and the secondary infiltrant metal powder approximately equalize the heating rate of the powders when irradiated with microwave energy.

Approximate equalization of the heating rates of the metal powders in the green part and the secondary infiltrant metal powder is a key aspect of embodiments of the present invention. When placed in a common microwave environment, two dissimilar metal powders, having similar particle sizes, will heat at different heating rates due to the difference in their specific heats and microwave coupling characteristics. This disparity in heating rates makes the microwave densification process difficult to control.

In an ideal microwave heating system, the heating rate of a material can be mathematically stated as:

dθ/dt=P/(M*s)

where:
dθ/dt=Heating rate in degrees per second
P=Microwave power in Kilowatts
M=Mass in Kilograms
s=Specific Heat in KiloJoules/Kilograms-Deg. Kelvin

As an example, stainless steel powder is used as the metal powder in the green part, bronze powder is used as the secondary infiltrant metal powder, each with the same particle size. The heating rate of 500 grams of stainless steel powder and 500 grams of bronze powder, exposed to 1 Kilowatt of microwave energy, will be calculated to show the difference in heating rates. The specific heat of stainless steel is 0.51 KiloJoules per Kilogram-Degrees Kelvin. The specific heat of bronze is 0.43 KiloJoules per Kilogram-Degrees Kelvin. The distribution of microwave energy is assumed to be homogeneous.

Since metal powders couple with microwave energy and heat volumetrically, the absorption of microwave energy will be approximately proportional to the mass of each of the powders. For this example, the microwave energy is split evenly between the two powders resulting in the following heating rate calculations:

Stainless Steel dθ/dt=0.5 KW/(0.5 kg*0.51 KJ/Kg-K)

Stainless Steel dθ/dt=1.96 deg./sec

Bronze dθ/dt=0.5 KW/(0.5 kg*0.43 KJ/Kg-K)

Bronze dθ/dt=2.33 deg./sec

If the metal powders are jointly exposed to 1 KW of microwave energy for five minutes (300 seconds) and no heat loss is assumed, the temperature of the metal powders would be as follows:

Stainless steel=588 deg. Celsius

Bronze=699 Deg. Celsius

As shown above, there is a temperature differential of 111 degrees Celsius between the metal powders. In other terms, bronze will heat up to a temperature 1.19 times higher than stainless steel during microwave processing. Since the microwave densification process of the present invention is continuous and takes place in a common, atmosphere controlled environment, the temperature differential between the two powders must be approximately equalized in order to achieve temperature control of the entire microwave densification process.

Embodiments of the present invention exploit the microwave absorption behavior of metal powders to approximately equalize their heating rates. The absorption of microwave energy by metal powders is dependent on the particle size of the powder and the green density of the part. In general terms, as green density increases, heating rates decrease. Conversely, as particle size increases, heating rates decrease.

For certain embodiments of the present invention, the green density of a fully debound part can vary from 50% to 95%. Conversely, the amount of binder can vary from 5% to 50% in such embodiments. Once the green density of the part has been determined, the particle size of the base metal powder and the secondary infiltrant metal powder can be selected such that their heating rates are approximately equalized when exposed to microwave energy.

For each combination of metal powders in the green part and secondary metal infiltrant powder, there is an ideal particle size ratio between the powders that results in the heating rates being approximately equalized.

To execute the microwave densification process of the present disclosure, a green part is placed in contact with the secondary infiltrant metal powder and placed inside a microwave applicator under a controlled atmosphere to prevent oxidation of the metal powders. The particle size ratio between the metal powders in the green part and the secondary infiltrant metal powder should be previously selected to approximately equalize the heating rates of the powders. This approximate equalization is needed to maintain control of the temperature during densification.

Microwave densification takes place in a continuous, uninterrupted cycle starting with debinding the green part with microwave energy to thermally decompose any binders leaving behind a brown part. A brown part is a green part that has had all the binder removed, leaving a lightly sintered, porous metal skeleton. After thermal debinding, the brown part is microwave sintered to a partial density at a temperature which is lower than the melting temperature of the secondary infiltrant metal powder.

This is followed by microwave infiltration with the secondary infiltrant metal powder at a temperature which is higher than the melting point of the infiltrant metal powder but lower than melting temperature of the metal powders in the green part. The melted secondary infiltrant metal powder can be absorbed into the porous brown part by capillary action, resulting in a fully dense metal part with minimal dimensional deviations and free of defects.

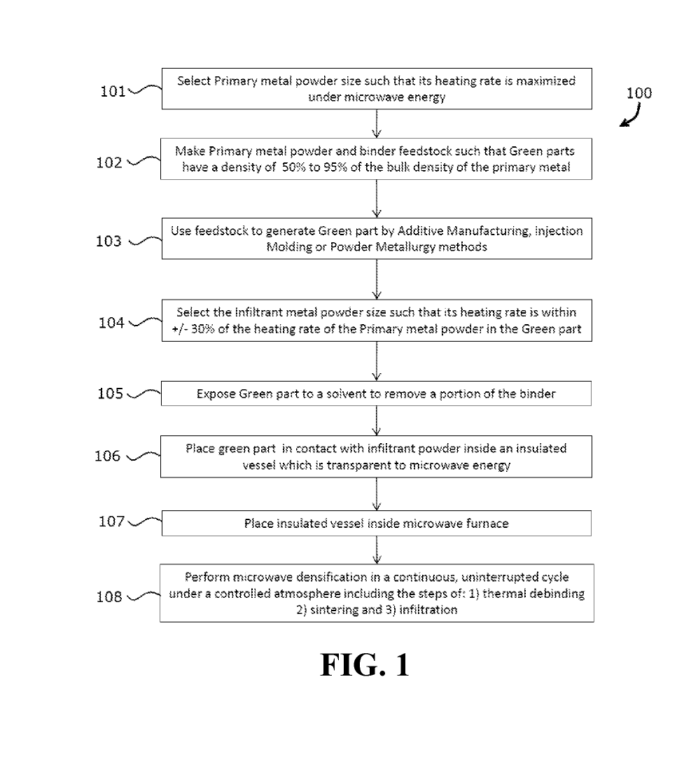

Referring now to FIG. 1, a flow chart is provided for steps involved in one specific embodiment of a microwave densification process 100 according to the present invention. As shown in FIG. 1, process 100 includes a first step 101 involving selecting a primary metal powder size such that its heating rate is maximized under microwave energy. Process 100 next involves step 102 of making primary metal powder and binder feedstock such that green parts have a density of 50% to 95% of the bulk density of the primary metal. Step 103 involves using feedstock to generate a green part by a suitable process (e.g. additive manufacturing, injection molding or powder metallurgy methods). Next, process 100 involves step 104, which involves selecting the infiltrant metal powder size such that its heating rate is approximately equal (e.g. within +/−30%) to the heating rate of the primary metal powder in the green part. In other words, the heating rate of the secondary infiltrant powder is greater than 70 percent and less than 130 percent of the heating rate of the primary metal powder.

The embodiment shown in FIG. 1 next involves step 105, which includes exposing the green part to a solvent to remove a portion of the binder. This can be followed by step 106, which involves placing the green part in contact with an infiltrant powder inside an insulated vessel that is transparent to microwave energy. The next step in process 100 includes step 107, which involves placing the insulated vessel inside a microwave densification chamber (e.g. a microwave furnace). Process 100 follows with step 108, which involves performing microwave densification in a continuous, uninterrupted cycle under a controlled atmosphere, which further includes: (1) thermal debinding; (2) sintering; and (3) infiltration. As previously noted, continuous microwave densification methods perform the steps of thermal debinding, sintering and infiltration without the need to access or otherwise manipulate the green part, the brown part or the infiltrant metal powder within the microwave furnace once the microwave irradiation process begins.

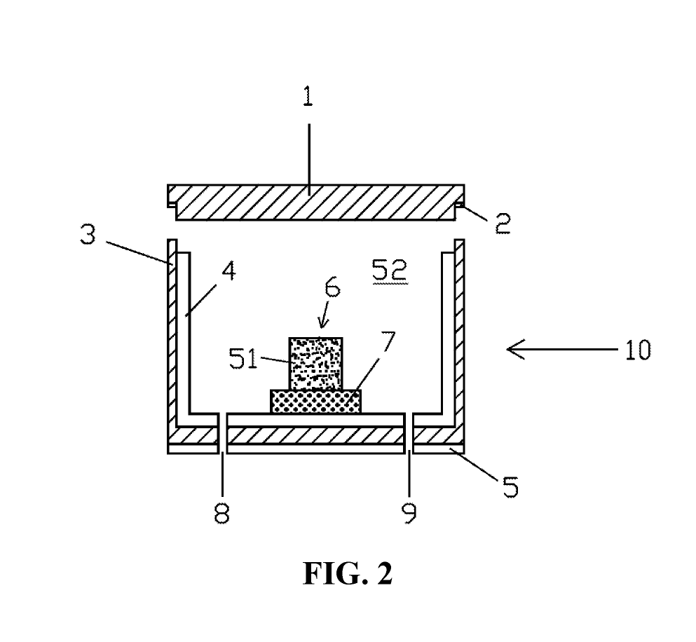

Exemplary embodiments of the present disclosure include apparatus configured to conduct aspects of process 100. For example, FIG. 2 illustrates an insulated densification vessel 10 suitable for use as the insulated vessel used in steps 106-108 of process 100 in FIG. 1. In the embodiment illustrated in FIG. 2, densification vessel 10 comprises a cover 1 and a containment structure 3. Cover 1 is illustrated detached from containment structure 3 in FIG. 2. It is understood that cover 1 can be coupled to containment structure 3 to surround an interior volume 52 in densification vessel 10. In exemplary embodiments, densification vessel 10 may be constructed from high temperature microwave transparent materials capable of withstanding mechanical loads imposed by a vacuum.

In the embodiment shown, cover 1 further comprises a vacuum seal 2, while containment structure 3 further comprises internal insulation 4. In addition, containment structure 3 also comprises a first port 9 (which may be coupled to a vacuum source) and second port 8 (which may be coupled to a source of an inert gas). First port 9 and second port 8 are in fluid communication with interior volume 52, such that a vacuum can be placed on interior volume 52 and/or an inert gas can be directed to interior volume 52 as desired.

In the illustrated embodiment, the bottom side of the containment structure 3 comprises a vacuum seal 5. As shown in FIG. 2, a green part 6 made from metallic particulate held by a binder 51 and infiltrating metal powder 7 are shown inside interior volume 52 of densification vessel 10.

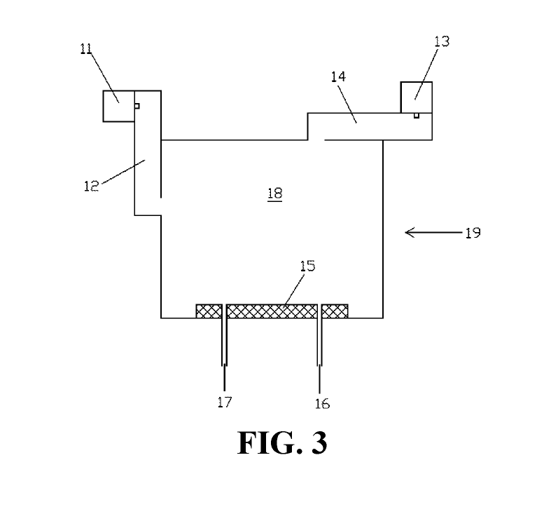

Referring now to FIG. 3, an embodiment of a microwave densification chamber 19 (e.g. a microwave furnace) made from lightweight microwave reflective materials is shown. In exemplary embodiments, microwave densification chamber 19 is suitable for use in steps 107-108 of process 100 in FIG. 1.

In the illustrated embodiment, microwave densification chamber 19 comprises a solid state microwave source 11, which radiates microwave energy into a waveguide 12 during operation. In the embodiment shown, microwave densification chamber 19 also comprises a second solid state microwave source 13 that radiates microwave energy into a waveguide 14. Microwave densification chamber 19 further comprises a chamber volume 18 with a base plate 15, a first port 16 coupled to a vacuum source and a second port 17 coupled to an inert gas source.

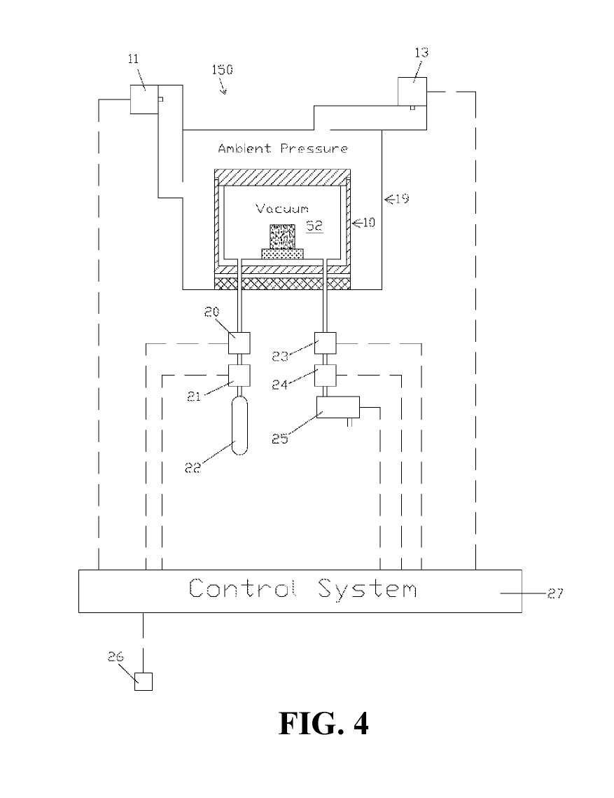

Referring now to FIG. 4, a system 150 is shown with high temperature densification vessel 10 located inside microwave densification chamber 19. For purposes of clarity, not all elements are labeled with references numbers in the figures. When densification vessel 10 is placed inside chamber volume 18 of microwave densification chamber 19, first port 17 and second port 16 can be coupled to first port 9 and second port 8, respectively. Accordingly, an inert gas can be directed to interior volume 52 when densification vessel 10 is located within chamber volume 18 and a vacuum (e.g. reduced pressure) can be placed on interior volume 52.

In the embodiment shown, system 150 comprises a solenoid valve 20 to control the flow of inert gases, which is coupled to a pressure sensor 21, which in turn is coupled to a pressurized inert gas tank 22. In this embodiment, system 150 also comprises a vacuum sensor 23, which is coupled to solenoid valve 24 to control the vacuum in interior volume 52. Solenoid valve 24 is also coupled to a vacuum pump 25 configured to reduce the pressure in interior volume 52.

In the illustrated embodiment, system 150 includes a control system 27 coupled to solid state microwave sources 11 and 13, solenoid valve 20, pressure sensor 21, vacuum sensor 23, solenoid valve 24, vacuum pump 25 and ambient temperature sensor 26. During use, control system 27 can control components of system 150 to regulate operational parameters, including for example, temperature within interior volume 52.

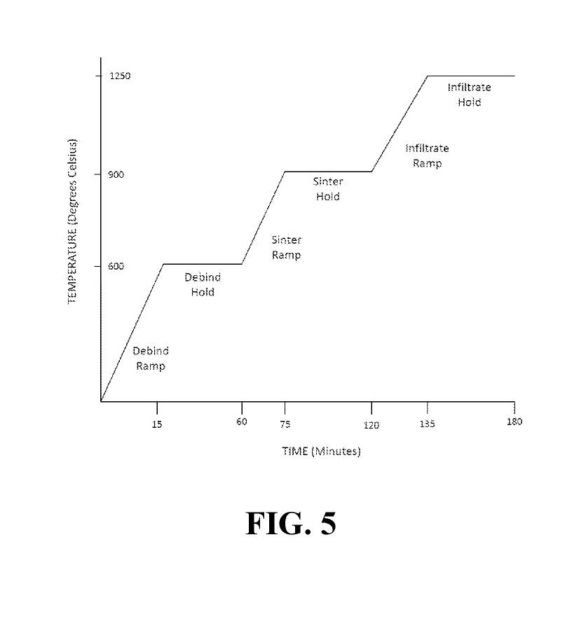

FIG. 5 shows a typical temperature versus time heating profile for microwave densification, which includes profile segments for debinding, sintering and infiltration. It is understood the time and temperature ranges shown in FIG. 5 are just examples for one embodiment, and that other heating profiles for different embodiments will have different time and temperature ranges.

In the embodiment shown, the debind ramp segment increases the temperature from ambient to approximately 600 degrees Celsius over a period of time of approximately 15 minutes. This temperature is then held for approximately 45 additional minutes in the debind hold segment. In this embodiment, a sinter ramp segment increases the temperature to approximately 900 degrees Celsius over a period of time of approximately 15 minutes. This temperature is then held for approximately 45 additional minutes in the sinter hold segment. In the embodiment of FIG. 5, the infiltrate ramp segment increases the temperature to approximately 1250 degrees Celsius over a period of time of approximately 15 minutes. This temperature is again held for approximately 45 additional minutes in the infiltrate hold segment. As previously noted, the temperature and time ranges illustrated in FIG. 5 are merely exemplary, and other embodiments may include different parameters than those shown and described here.

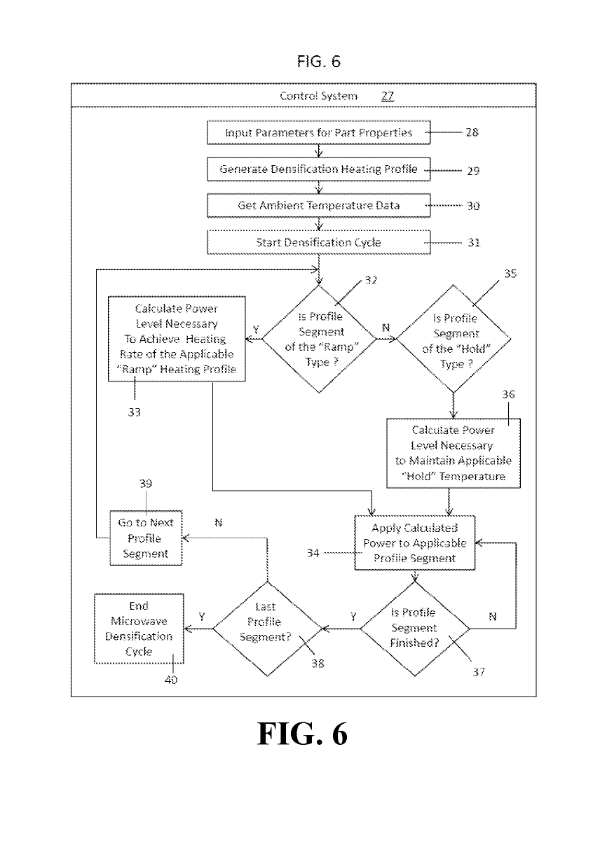

Referring now to FIG. 6, a flow chart is illustrated of steps taken by control system 27 to execute and control the microwave densification cycle in one exemplary embodiment. In the embodiment shown, a user can input the parameters for part properties in step 28 (e.g. properties for green part 6 shown in FIG. 2). In exemplary embodiments, the part properties can include the type of material, mass, volume, surface area and thickness of the part.

In exemplary embodiments, the input of the parameters may be accomplished by manual or electronic means, including for example, wireless transmission. Utilizing the values of the parameters for part properties 28, control system 27 can use a reference database to generate a microwave densification heating profile 29 that includes time and temperature values for the heating profile segments corresponding to debinding, sintering and infiltration. An example of one embodiment of a microwave densification heating profile is shown in FIG. 5.

As shown in FIG. 6, an ambient temperature sensor can provide control system 27 ambient temperature data 30 prior to the start of densification cycle 31. After the start of the densification cycle 31, the control system 27 starts executing the densification heating profile 29. If the profile segment is of the “Ramp” type 32 ramping to a temperature, the control system 27 uses an algorithm to calculate the microwave power level 33 necessary to achieve the heating rate specified by the densification heating profile 29 without the need for direct temperature feedback. In exemplary embodiments, the algorithm is based on analytical data and design of experiment techniques which provide a mathematical representation used to calculate the microwave power required for the corresponding heating profile segment.

The calculated microwave power 33 necessary to achieve the heating rate is applied in step 34 for the time specified by the densification heating profile 29 until the profile segment is finished. If the profile segment is of the “Hold” type in step 35, control system 27 uses an algorithm to calculate the microwave power level 36 necessary to maintain the temperature specified by the densification heating profile 29 without the need for direct temperature feedback. In exemplary embodiments, the algorithm is based on analytical data and design of experiment techniques which provide a mathematical representation used to calculate the microwave power required to maintain the temperature of corresponding heating profile segment.

The calculated microwave power 36 necessary to maintain the temperature is applied in step 34 for the time specified by the densification heating profile 29 until the profile segment is finished in step 37. During the application of the calculated power to the applicable profile segment 34, control system 27 can modulate the amplitude, frequency and phase of the microwave energy to minimize losses related to reflected microwave energy and provide homogeneous distribution of the microwave energy.

In exemplary embodiments, control system 27 can monitor the heating profile segment and determine if the profile segment is finished in step 37. If the heating profile segment is not finished, control system 27 can continue to apply power until the profile segment is finished as defined by the densification heating profile 29. If the profile segment is finished in step 37, control system 27 can determine if that was the last heating profile segment in step 38. If it is not the last profile segment, control system 27 goes to the next profile segment in step 39. If it is the last profile segment, control system 27 ends the microwave densification cycle.

As described herein, exemplary embodiments of the present disclosure provide operational benefits to address issues with existing technologies.

All of the devices, systems and/or methods disclosed and claimed herein can be made and executed without undue experimentation in light of the present disclosure. While the devices, systems and methods of this invention have been described in terms of particular embodiments, it will be apparent to those of skill in the art that variations may be applied to the devices, systems and/or methods in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

The following list of references are incorporated herein by reference:
U.S. Pat. No. 5,874,377
U.S. Pat. No. 6,183,689
U.S. Pat. No. 6,238,614
U.S. Pat. No. 7,070,734
U.S. Pat. No. 7,326,892
U.S. Pat. No. 7,541,561
U.S. Pat. No. 7,713,350
U.S. Pat. No. 7,857,193
U.S. Pat. No. 8,431,071
U.S. Pat. No. 8,496,869
U.S. Pat. No. 8,562,765
U.S. Pat. No. 8,863,816
U.S. Pat. No. 9,074,267
US 20060251536
US 20040144203
US 20040238794
US 20050249627
US 20160369881
CA 2,124,093
Allan et al., “Microwave Heating Technologies”, Heat Treating Process, May/June 2008, pp. 39-42.

1. A method of microwave densification of a component, the method comprising:
placing a component inside a microwave furnace, wherein the component comprises a binder and a first metal powder;
placing a second metal powder in contact with the component; and
irradiating the component and the second metal powder with microwave energy in a continuous microwave densification process to thermally debind and sinter the component and to infiltrate the component with the second metal powder.

2. The method of claim 1 wherein:
the first metal powder has a first heating rate when the component is irradiated with microwave energy in the continuous microwave densification process;
the second metal powder has a second heating rate when the second metal powder is irradiated with microwave energy in a continuous microwave densification process;
the second heating rate is greater than 70 percent of the first heating rate; and
the second heating rate is less than 130 percent of the first heating rate.

3. The method of claim 2 wherein:
the second heating rate is greater than 80 percent of the first heating rate; and
the second heating rate is less than 120 percent of the first heating rate.

4. The method of claim 2 wherein:
the second heating rate is greater than 90 percent of the first heating rate; and
the second heating rate is less than 110 percent of the first heating rate.

5. The method of claim 1, wherein:
the first metal powder comprises metal particles with a first particle size;
the first metal powder has a first heating rate when the component is irradiated with microwave energy in the continuous microwave densification process;
the second metal powder comprises metal particles with a second particle size;
the second metal powder has a second heating rate when the component is irradiated with microwave energy in the continuous microwave densification process; and
the method further comprises controlling a ratio of the first particle size to the second particle size such that the second heating rate that is between 70 percent and 130 percent of the first heating rate.

6. The method of claim 5 wherein the method further comprises controlling a ratio of the first particle size to the second particle size such that the second heating rate that is between 80 percent and 120 percent of the first heating rate.

7. The method of claim 5 wherein the method further comprises controlling a ratio of the first particle size to the second particle size such that the second heating rate that is between 90 percent and 110 percent of the first heating rate.

8. The method of claim 1 wherein the component is generated by injection molding of the metal powder held by the binder.

9. The method of claim 1 wherein the component is generated by additive manufacturing of the metal powder held by the binder.

10. The method of claim 1 wherein the component is generated by compacting the metal powder with the binder in a powder metallurgy press.

11. The method of claim 1 further comprising exposing the component to a solvent to remove a portion of the binder.

12. The method of claim 1 wherein:
the metal powder has first density;
the component has a second density; and
the second density is between 50 percent and 95 percent of the first density.

13. The method of claim 12 wherein the microwave energy has a frequency from 0.8 to 90 GHz.

14. The method of claim 1 wherein the component is placed inside an insulated vessel inside the microwave furnace.

15. The method of claim 14 further comprising placing a vacuum on the insulated vessel.

16. The method of claim 14 further comprising introducing an inert gas into the insulated vessel.

17. The method of claim 1 wherein:
the component is sintered at a first temperature;
the component is infiltrated with the second metal powder at a second temperature; and
the first temperature is lower than the second temperature.

18. The method of claim 1 wherein the second metal powder has a lower melting temperature than the melting temperature of the first metal powder.

19. The method of claim 1 wherein:
the component comprises a first volume;
the second metal powder comprises a second volume; and
the second volume is between 5 and 50 percent of the first volume.

20. An apparatus for microwave densification, the apparatus comprising:
a microwave densification chamber comprising:
a first microwave energy source;
a first waveguide; and
a chamber volume; and
a control system coupled to the first microwave energy source, wherein:
the first microwave energy source is configured to radiate microwave energy into the first waveguide and irradiate the chamber volume with microwave energy; and
the control system is configured to modulate parameters of the microwave energy source such that microwave chamber is irradiated with microwave energy to maintain a temperature versus time heating profile for microwave densification.

21. The apparatus of claim 20 wherein the temperature versus time heating profile comprises:
a first profile segment for increasing temperature inside the chamber volume;
a second profile segment for maintaining temperature inside the chamber volume;
a third profile segment for increasing temperature inside the chamber volume;
a fourth profile segment for maintaining temperature inside the chamber volume;
a fifth profile segment for increasing temperature inside the chamber volume; and
a sixth profile segment for maintaining temperature inside the chamber volume.

22. The apparatus of claim 21 wherein:
the first and second profile segments are configured to debind a component comprising a binder and a first metal powder in the chamber volume;
the third and fourth profile segments are configured to sinter the component; and
the fifth and sixth profile segments are configured to infiltrate the component with a second metal powder.

23. The apparatus of claim 20 wherein the parameters of the microwave energy source include an amplitude, a frequency or a phase of the microwave energy.

24. The apparatus of claim 20 wherein the control system is configured to generate the temperature versus time heating profile for microwave densification.

25. The apparatus of claim 20 wherein the control system is configured to automatically generate the temperature versus time heating profile for microwave densification based on input parameters.

26. The apparatus of claim 25 wherein the input parameters include material properties of a component for microwave densification.

27. The apparatus of claim 26 wherein the material properties include material type, volume, surface area or thickness.

28. The apparatus of claim 20 further comprising an insulated vessel located within the microwave densification chamber, wherein the insulated vessel comprises an interior volume.

29. The apparatus of claim 28 wherein the insulated vessel is formed from microwave transparent materials.

30. The apparatus of claim 28 further comprising:
a first port in fluid communication with the interior volume of the insulated vessel; and
a second port in fluid communication with the interior volume of the insulated vessel.

31. The apparatus of claim 30 wherein:
the first port is coupled to a vacuum source; and
the second port is coupled to an inert gas source.

32. The apparatus of claim 31 further comprising:
a first valve in fluid communication with the first port; and
a second valve in fluid communication with the first port.

33. The apparatus of claim 32 wherein the control system is configured to control the first valve and the second valve.

34. The apparatus of claim 20 wherein the microwave densification chamber comprises microwave reflective materials.

35. The apparatus of claim 20 wherein the control system comprises an indirect temperature control system that uses a predictive algorithm to control a temperature of a component in the microwave densification chamber during microwave densification without direct temperature feedback.

36. The apparatus of claim 35 wherein:
the temperature versus time heating profile comprises one or more ramp profile segments for increasing temperature inside the chamber volume;
the temperature versus time heating profile comprises one or more hold profile segments for maintaining temperature inside the chamber volume; and
the algorithm is based on analytical data to calculate microwave power required for the one or more ramp profile segments and for the one or more hold profile segments.
